(19) United States
(12) Patent Application Publication
(10) Pub. No.: US 2005/0285935 A1
(43) Pub. Date: Dec. 29, 2005

(54) Personal conferencing node

(75) Inventors: Richard Hodges, Oakland, CA (US); Keith McMillen, Berkeley, CA (US); Leif Claesson, Oakland, CA (US); Keith Edwards, Antioch, CA (US)

Correspondence Address: PLANTRONICS INC;LEGAL/ INTELLECTUAL PROPERTY DEPARTMENT, 345 ENCINAL STREET, SANTA CRUZ, CA, 95060, US

(73) Assignee: Octiv, Inc., Berkeley, CA (US)

(21) Appl. No.: 10/881,992

(22) Filed: Jun. 29, 2004

(51) Int. Cl. H04M 1/24

(52) U.S. Cl. 348/14.08; 379/14.01

(57) ABSTRACT

A conferencing device is described which includes at least one speaker, at least one microphone for capturing energy corresponding to near-end speech, a signal interface for connecting to a voice communication system, and a digital signal processor. The digital signal processor is operable to process near-end signals corresponding to the near-end speech energy in each of a plurality of frequency bands to improve intelligibility thereof, and transmit the processed near-end signals to the voice communication system via the signal interface. The digital signal processor is also operable to receive far-end signals from the voice communication system via the signal interface, process the far-end signals in each of the plurality of frequency bands, and transmit the processed far-end signals for presentation over the speaker.

### BACKGROUND OF THE INVENTION

The present invention relates to digital signal processing of audio signals, and more particularly to techniques for facilitating high quality, full duplex teleconferencing.

Anyone who participates in teleconferencing is aware of the shortcomings of the vast array of technology offerings in this area. Many conference phones provide half duplex operation in which only one end of the conversation can speak at a time. This unnatural, “walkie-talkie” conversational style has proven to be a significant impediment to the acceptance and use of such solutions.

On the other hand, systems purporting to offer full duplex operation often suffer from echo or feedback (i.e., howling) unless appropriate signal processing techniques are applied. However, the application of such techniques often results in a user experience which is not significantly better than brute force half duplex solutions.

Another shortcoming associated with many conferencing systems is the quality of the audio delivered. That is, many systems deliver poor quality audio that is either distorted in some way, or all but unintelligible due to background noise or inadequate hardware. This is particularly the case for many voice applications for personal computers.

Moreover, the high quality large-room conference systems which are currently available are not appropriate for many applications. For example, there is a significant demand for hands free operation in individual offices where the deployment of such systems would be inappropriate or impractical. On the other hand, the poor quality and half-duplex operation found on most speakerphones, or the inadequacies of many voice over IP (VoIP) applications are not conducive for “serious” or long term phone conversations.

It is therefore desirable to provide conferencing solutions which address these shortcomings.

### SUMMARY OF THE INVENTION

According to the present invention, a conferencing device is provided which includes at least one speaker, at least one microphone for capturing energy corresponding to near-end speech, a signal interface for connecting to a voice communication system, and a digital signal processor. The digital signal processor is operable to process near-end signals corresponding to the near-end speech energy in each of a plurality of frequency bands to improve intelligibility thereof, and transmit the processed near-end signals to the voice communication system via the signal interface. The digital signal processor is also operable to receive far-end signals from the voice communication system via the signal interface, process the far-end signals in each of the plurality of frequency bands, and transmit the processed far-end signals for presentation over the speaker.

According to one implementation, the voice communication system corresponds to a telephone system and the signal interface is operable to interface with analog signals from the telephone system. According to another implementation, the signal interface is operable to interface with digital signals from the voice communication system.

According to one embodiment, the digital signal processor comprises a combiner block for generating a combination of the near-end signals from multiple microphones which employs a beam forming algorithm.

According to a specific embodiment, the digital signal processor comprises at least one echo canceller for rejecting energy in the near-end signals corresponding to far-end speech. Such energy might result, for example, from the pickup of far-end speech as might be caused by echoes. According to another specific embodiment, the digital signal processor comprises a line echo canceller for rejecting energy in the far-end signals corresponding to near-end speech. Such energy might be caused in some implementations, for example, by reflection of signals at a hybrid circuit used to interface between the telephone and line.

According to a specific embodiment, the digital signal processor comprises a near-end multi-band signal processor which is operable to separate the near-end signals into a plurality of signal components each corresponding to one of the frequency bands, independently and dynamically control a dynamic range associated with each one of the plurality of signal components, modify at least one signal level associated with the plurality of signal components, and recombine the signal components.

According to another specific embodiment, the digital signal processor comprises a far-end multi-band signal processor which is operable to separate the far-end signals into a plurality of signal components each corresponding to one of the frequency bands, independently and dynamically control a dynamic range associated with each one of the plurality of signal components, modify at least one signal level associated with the plurality of signal components, and recombine the signal components.

According to one embodiment, the digital signal processor comprises a speaker compensation block which is operable to compensate for the non-ideal characteristics of the at least one speaker. According to a more specific embodiment, the speaker compensation block comprises a minimum phase filter. According to an even more specific embodiment, the minimum phase filter is derived from the inverse of the frequency characteristics of the at least one speaker.

A further understanding of the nature and advantages of the present invention may be realized by reference to the remaining portions of the specification and the drawings.

### BRIEF DESCRIPTION OF THE DRAWINGS

FIG. 1 is a simplified block diagram of an exemplary conferencing device designed according to a specific embodiment of the invention.

FIG. 2 is a simplified block diagram illustrating the signal processing functions associated with an exemplary conferencing device designed according to a specific embodiment of the invention.

FIG. 2a is a simplified block diagram illustrating an alternative configuration for a portion of the conferencing device illustrated in FIG. 2.

FIG. 3 is a perspective view of an exemplary conferencing device designed according to a specific embodiment of the invention.

FIG. 4 is a cross-sectional view of the conferencing device of FIG. 3.

### DETAILED DESCRIPTION OF SPECIFIC EMBODIMENTS

Reference will now be made in detail to specific embodiments of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims. In the following description, specific details are set forth in order to provide a thorough understanding of the present invention. The present invention may be practiced without some or all of these specific details. In addition, well known features may not have been described in detail to avoid unnecessarily obscuring the invention.

According to the invention, a conferencing system is provided which provides full duplex operation and generates high quality audio. According to specific embodiments, a “personal conferencing node” is provided which may be easily deployed on a desk top and may be integrated with a variety of voice communication systems including, for example, analog and digital phone systems, wireless communication devices, and a wide variety of software-based voice applications.

According to some embodiments, the conferencing node is connected in series with a phone handset which needs to be picked up to provide the analog signals to the conferencing node. The signals go through the conferencing node to the handset unless the conferencing node is activated, in which case, the handset is cut off. If the conferencing node is connected to a wireless device, e.g., a cell phone, the wireless device user can use the conferencing node by answering the call with the wireless device, e.g., pressing the “send” button, and then activating the conferencing node.

The analog signals from the phone are typically carried on four wires; two wires from the phone to the speaker in the handset, and two wires from the microphone in the handset to the phone. In such embodiments, the placement of the conferencing node between the phone and the handset takes advantage of the fact that the signals are already separated, thereby avoiding having to include circuitry for separating the signals, e.g., a hybrid, in the device itself. These embodiments also leverage the ring voltage and tone circuitry in the phone which therefore do not need to be provided in the conferencing node.

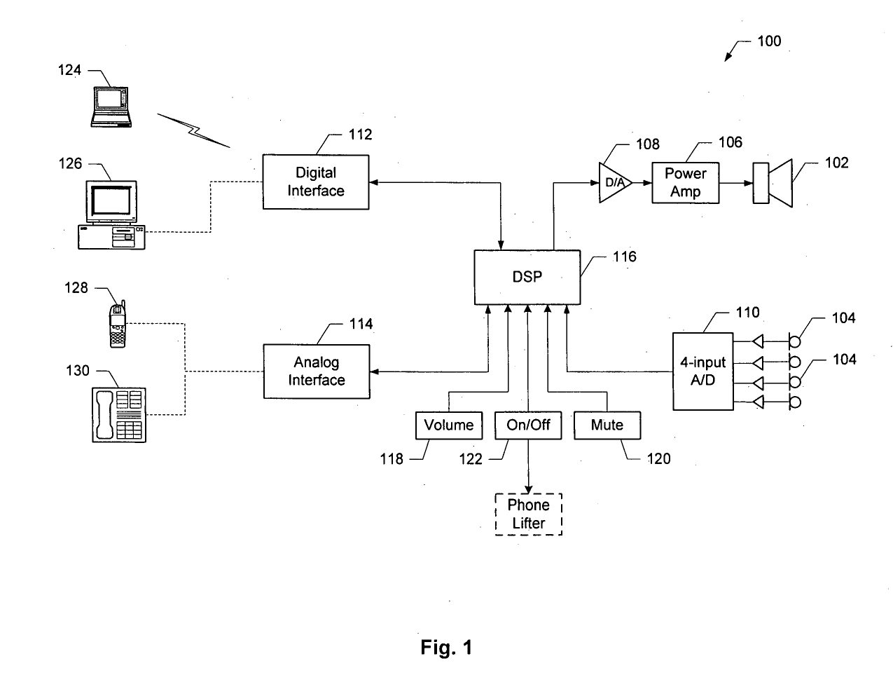

According to some embodiments in which the conferencing node is placed between a phone and its handset, the handset may be lifted (to thereby complete the call circuit) in response to activation of the device. For example, in response to hearing the phone ring or in preparation for making a call, a user could activate the device (e.g., by pressing a button on the device) in response to which a mechanical handset lifter raises the handset out of its cradle sufficiently to answer or begin the call. The same device activation mechanism may be employed to cause the handset lifter to lower the handset into the cradle and terminate the call (e.g., see FIG. 1). Similar wireless embodiments are contemplated in which activation and deactivation of the conferencing node begins and terminates calls.

The typical hybrid employed by a telephone to separate incoming and outgoing signals provides approximately 6 to 18 dB of return loss between outgoing and incoming signals. This results in so-called side tones which are manifested, for example, as the sound of one's own voice in the handset speaker. While this degree of separation may be sufficient (and even desirable) for the typical handset, a much greater degree of separation may be desirable for other applications, e.g., conferencing. In addition, greater return loss may be required to eliminate feedback and howling. Therefore, according to some embodiments, additional echo cancellation circuitry is provided in the device to provide a much higher separation between incoming and outgoing signals than is typically provided by the phone's hybrid. This will be discussed in further detail below.

According to some embodiments, the conferencing node of the present invention connects with a personal computer or other digital device (e.g., using USB (1 or 2), Bluetooth, variants of 802.11, or other wireless techniques) and interacts with “soft phone” software on the digital device. This includes any application (H323, SIP, etc.) that allows 2-way communication using a headset or free-air speakers and microphone. In such embodiments, for example, a simple video conferencing system can be implemented using the conferencing node and an inexpensive camera. As will be seen, embodiments of the present invention also provide multi-band digital signal processing of the incoming and outgoing voice signals to result in a very high quality user experience. This to be contrasted with the typically poor user experience associated with many “voice over IP” (VoIP) applications which employ low quality free-air microphones and multimedia speakers with little or no signal processing. In fact, the user experience has been so bad for such applications that many providers of Internet conferencing services have forced their users to go back to using phones for the audio portions of such conferences.

Embodiments of the present invention may also be employed with digital phones systems including, for example, all digital PBX phones such as Nortel, Siemens, Panasonic, ATT, etc. More generally, the present invention may be implemented in conjunction with any voice communication system which digitally encodes speech energy. All that is required for compatibility is appropriate coding and decoding at the interface.

According to a specific embodiment shown in FIG. 1, a hands-free conferencing device is provided which, with minor variations to its interface circuitry, may be implemented for both digital and analog implementations. Conferencing node 100 has a speaker 102 and a plurality (in this case 4) of directional microphones 104. Speaker 102 is driven by a power amplifier 106 which, in turn, is driven by digital-to-analog (D/A) converter 108. The signals from microphones 104 are received and converted to digital form by a multi-input analog-to-digital (A/D) converter 110.

As discussed above, conferencing node 100 may be configured to receive and transmit digital data or packets over wired (e.g., USB 1 or 2) or wireless (e.g., Bluetooth or 802.11) interfaces from any of a variety of digital devices (e.g., computers 124 and 126). In such embodiments, the packets may be received and transmitted using a digital interface (e.g., a chip set) 112 which can handle the protocol and/or data format according to which the packets are transmitted. For example, interface 112 may comprise a USB or Bluetooth media access control (MAC) chip set. In the case of a wireless embodiment, a suitable antenna or infrared interface (not shown) would be provided for transmitting and receiving the packets. In general, the nature of interface 112 may be as varied as the available digital solutions in this area.

Alternatively, conferencing node 100 may be configured to receive and transmit analog signals, e.g., two-wire or four-wire signals from a desktop or wireless phone handset (e.g., phones 128 and 130). In the four-wire case, interface 114 (e.g., a codec) makes the necessary signal conversions to and from the digital domain. In the two-wire case, a hybrid circuit (not shown) may also be provided to separate the incoming and outgoing signals.

Conferencing node 100 also includes a digital signal processor (DSP) 116 which controls the operation of the device. DSP 116 may be, for example, provided by Analog Devices, Inc. Depending on the embodiment, DSP 116 interfaces with either interface 112 or 114. DSP 116 also provides digital audio data to D/A converter 108 for playing over speaker 102, and receives input from microphones 104 via A/D converter 110. DSP 116 also receives input from various user interface components including, for example, a volume encoder 118, a mute circuit/switch 120, and an on/off circuit 122.

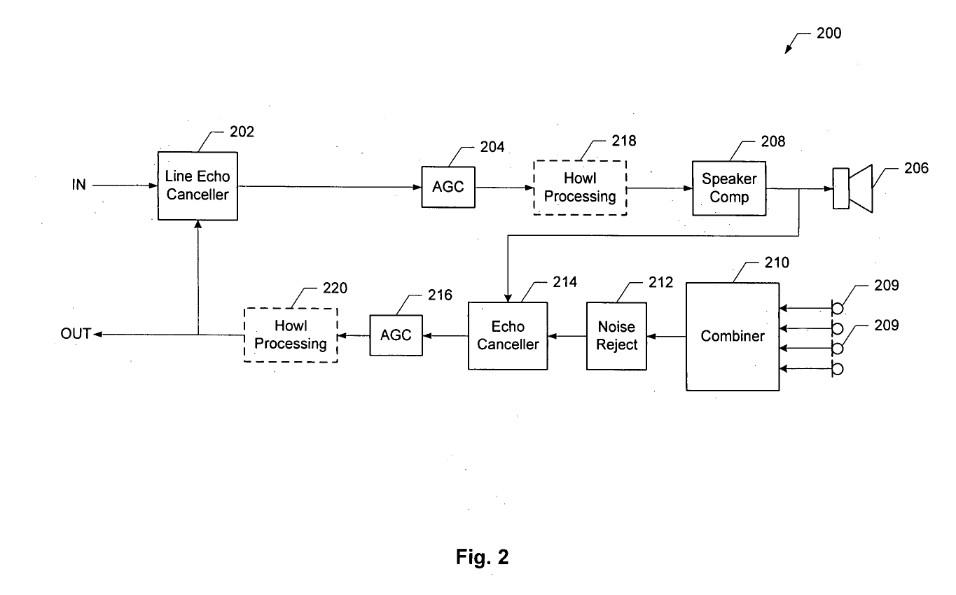

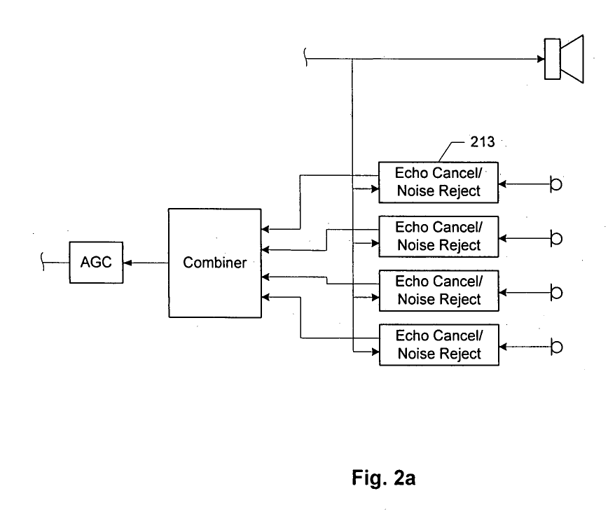

Operation of a specific embodiment of the conferencing node 200 of the present invention will now be described with reference to the functional block diagram of FIG. 2. It will be understood that most of the functional blocks shown and functions described may be implemented, for example, with DSP 116 of FIG. 1.

A line echo canceller 202 may be used to receive the incoming voice from the far side of the conversation. Any of a wide variety of echo cancellation techniques may be employed. And it will be understood that this will be more appropriate for analog embodiments in which additional separation between incoming and outgoing signals is desirable, but may not be needed for digital applications, e.g., PC soft phones, in which the separation issue does not arise.

An automatic gain control (AGC) block 204 provides processing of the far-end speech to improve the quality of the sound delivered by speaker 206. According to various embodiments, the nature of this processing may vary considerably without departing from the scope of the invention. According to a specific embodiment, AGC 204 provides multi-band processing of the received signal and is implemented according to the techniques described in U.S. patent application Ser. No. 10/214,944 for DIGITAL SIGNAL PROCESSING TECHNIQUES FOR IMPROVING AUDIO CLARITY AND INTELLIGIBILITY filed on Aug. 6, 2002 (Attorney Docket No. OCTVP001X1), and U.S. patent application Ser. No. 10/696,239 for TECHNIQUES FOR IMPROVING TELEPHONE AUDIO QUALITY filed on Oct. 28, 2003 (Attorney Docket No. OCTVP008), the entire disclosures of both of which are incorporated herein by reference for all purposes.

According to a specific embodiment, a speaker compensation block 208 is also provided to compensate for the non-ideal characteristics of speaker 206. Again, it should be noted that such compensation is not required, and the nature of this compensation may vary widely without departing from the scope of the invention. According to one embodiment, speaker compensation block 208 comprises a minimum phase filter. A matched filtering technique is used to measure the impulse response of the speaker. A Prony algorithm is then used to make a linear system model representing the poles and zeros of the measured response. A compensating filter can then be derived by converting the poles into zero and the zeros into poles.

However, any zeros lying outside the unit circle in the z-plane have the potential to become unstable poles. Therefore, the linear system model is first converted to a minimum phase form using standard techniques before the compensating filter is derived. According to a particular implementation, this conversion is effected through the use of an all-pass filter which converts all of the zeros outside the unit circle into zeros inside the unit circle. The resulting model may then be inverted to derive a minimum phase filter which provides highly precise compensation for the non-ideal characteristics of the speaker. This approach is particularly effective in that it is able to compensate for irregularities of the speaker response in the frequency and time domains.

According to an even more specific embodiment, one or more additional filter components are added to the minimum phase filter to prevent undesirable compensation from occurring in certain regions of the audio spectrum. That is, it is undesirable for the minimum phase filter to attempt to compensate overly much for the natural roll off of the speaker at the low and high ends. For example, without additional filtering, the minimum phase filter might attempt to boost the low end bass by an infinite amount, resulting in clipping and/or other undesirable artifacts. Therefore, a high pass filter may be added to the minimum phase filter to limit the latter's action in these regions.

It should be noted that speaker compensation may be achieved through a wide variety of other well known techniques. For example, techniques such as manual or automatic multi-band frequency equalization may be employed. Alternatively, speaker compensation may be omitted entirely.

In the implementation shown, the inputs from four directional microphones 209 are processed by a combiner block 210 which selects from among or combines the inputs from the different microphones in some way to generate a single signal. The algorithm employed by combiner block 210 may vary widely. For example, combiner block 210 may be a simple summing of the inputs from the different microphones. Alternatively, more sophisticated approaches may be employed. For example, combiner block 210 may be operable to pass only the input from one of the microphones based upon a determination as to which microphone is currently the most relevant, e.g., the microphone nearest the person currently speaking. According to one embodiment, combiner block 210 employs a beam forming algorithm which attempts to achieve an optimal linear combination of the various microphone inputs.

A noise rejection block 212 may also be employed to mitigate the effects of various types of noise in the system. According to various embodiments, block 212 may employ any of a wide variety of techniques which attempt to separate the desirable signal, i.e., speech from the person currently talking, from various sources of interference, e.g., peripheral noise, far end-speech, etc. Such techniques may include the use of, for example, Wiener filters, noise gates, spectral subtraction, and other techniques known in the art.

According to the embodiment shown, echo cancellation block 214 receives information from the signal being transmitted to speaker 206 and attempts to reject energy in the signal received from the microphones which corresponds to the acoustic energy from the speaker. The complete or at least partial cancellation of this energy allows the conferencing node of the present invention to operate in a true full duplex mode, i.e., both near-end and far-end participants in a conference can speak and be heard at the same time.

AGC block 216 provides processing of the near-end speech (i.e., speech captured by the microphones) to improve the quality of the sound delivered to the far-end participants. As discussed above with reference to AGC block 204, the nature of this processing may vary considerably without departing from the scope of the invention. According to a specific embodiment, AGC 216 provides multi-band processing and is implemented according to the techniques described in U.S. patent application Ser. Nos. 10/214,944 and 10/696,239 incorporated herein by reference above.

A common problem with many phone systems, even those with sophisticated echo cancellation, is the occurrence of howling under certain conditions. Howling is caused by a feedback condition in which acoustic energy from a system's speaker is captured by the microphone(s) and fed back around the loop to the speaker. Therefore, according to some implementations, howl processing blocks 218 and 220 may be introduced to mitigate this condition.

According to a specific embodiment, blocks 218 and 220 implement complementary comb filters which selectively pass frequency bands in one direction which are complementary to the frequency bands being passed in the other direction. As will be appreciated, this will serve to knock down the frequencies which are being fed around the loop under conditions in which howling might otherwise occur. In order to mitigate any potential negative effects on the quality of the audio delivered by the system, the complementary comb filters may be activated only where there is speech detected from both ends of a conversation, i.e., the “doubletalk” condition during which howling is most likely to occur. In other specific embodiments, the entire incoming and/or outgoing signals may be shifted slightly in frequency using well known side-band modulation techniques.

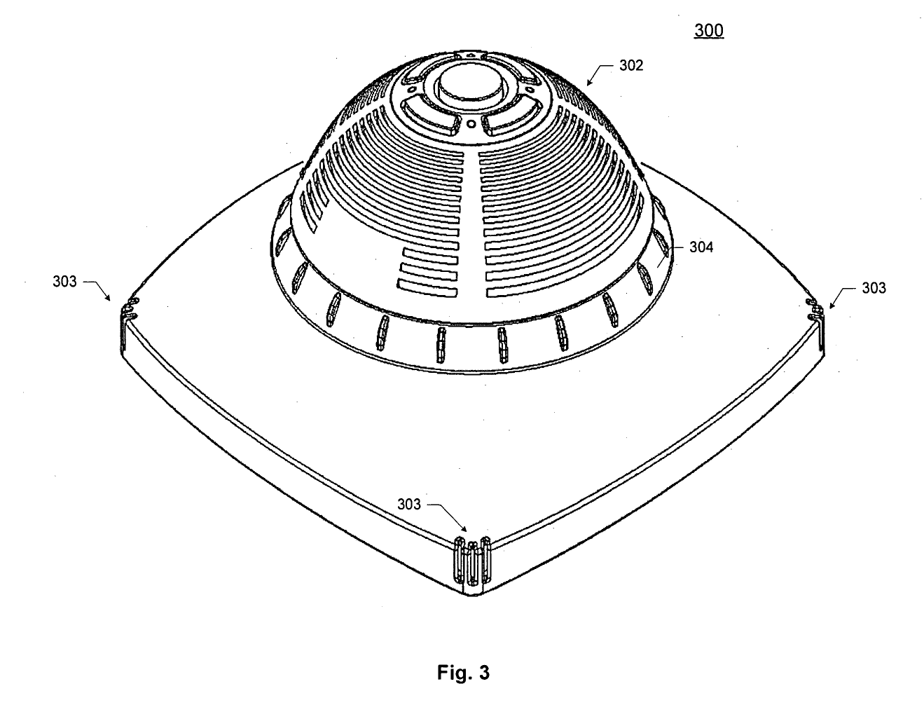

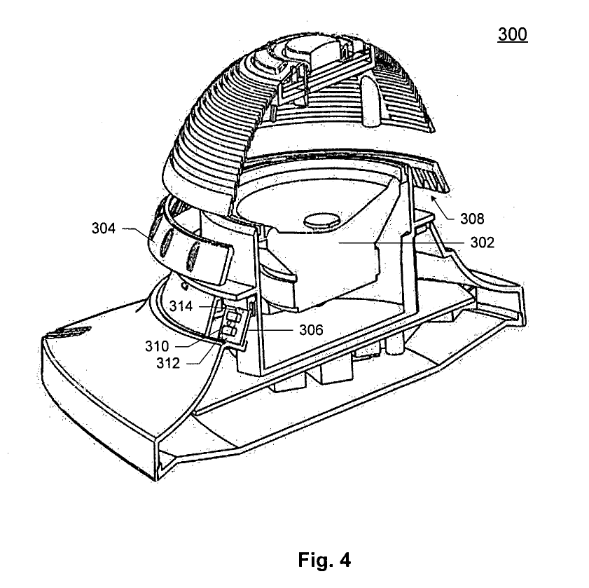

FIG. 3 is a perspective view of an exemplary conferencing device 300. FIG. 4 is a cross-sectional view of conferencing device 300. According to a specific embodiment, a personal conferencing node 300 has an upward-facing speaker 302, and a directional microphone 303 at each of the four corners of the square base of the device. The high dome shape makes it less likely that the device becomes covered with paper, even on the most cluttered of desks. A volume control signal for controlling the volume of speaker 302 is generated using volume control ring 304 and volume encoder board 306. Ring 304 is mounted such that it can be rotated around the central vertical axis of the device to increase or decrease the volume. Ring 304 has ridges, marks, or openings 308 spaced at regular intervals along its inner surface. Volume encoder board 306 has a light source 310, e.g., an LED, which shines light on the inner surface of ring 304, and two photo detectors 312 and 314 which are offset and configured to receive the light reflected from the inner surface of ring 304. The photo detectors generate output signals which represent the variations in the reflected light caused by marks (or openings) 308 passing LED 310. The detector output signals, which encode the number of marks passing the LED, may then be converted into digital information which is used by the conferencing node's DSP to adjust the speaker volume accordingly. The direction of rotation of the ring (and thus the direction of volume adjustment up or down) may be determined by comparing the two detector outputs.

While the invention has been particularly shown and described with reference to specific embodiments thereof, it will be understood by those skilled in the art that changes in the form and details of the disclosed embodiments may be made without departing from the spirit or scope of the invention. For example, various of the signal processing blocks of FIG. 2 are shown and described with references to functionalities which are presented as being discrete for purposes of clarity. However, it will be understood that the various processing blocks shown may be combined in various ways without departing from the scope of the invention. For example, combiner block 210, noise rejection block 212, and echo cancellation block 214 may be implemented in a single or multiple blocks of code.

In addition, the order of the processing blocks may be altered from that described above without departing from the invention. For example, the echo cancellation and noise rejection functions represented by blocks 214 and 212 may be placed before the signal combining function represented by block 210 such that there are four echo cancellation blocks and/or four noise rejection blocks (e.g., blocks 213), i.e., one for each microphone as shown in FIG. 2a. In another exemplary variation, echo cancellation and/or noise rejection is provided both before and after the signal combining function. Those of skill in the art will understand the wide variety of other alternative configurations and combinations which are within the scope of the invention.

Finally, although various advantages, aspects, and objects of the present invention have been discussed herein with reference to various embodiments, it will be understood that the scope of the invention should not be limited by reference to such advantages, aspects, and objects. For example, although true full-duplex operation may be facilitated by some embodiments of the invention, other embodiments are contemplated which do not necessarily provide that level of performance. Therefore, the scope of the invention should be determined with reference to the appended claims.

1. A conferencing device, comprising:
at least one speaker;
at least one microphone for capturing energy corresponding to near-end speech;
a signal interface for connecting to a voice communication system; and
a digital signal processor which is operable to process near-end signals corresponding to the near-end speech energy in each of a plurality of frequency bands to improve intelligibility thereof, and transmit the processed near-end signals to the voice communication system via the signal interface, the digital signal processor further being operable to receive far-end signals from the voice communication system via the signal interface, process the far-end signals in each of the plurality of frequency bands, and transmit the processed far-end signals for presentation over the speaker.

2. The conferencing device of claim 1 wherein the at least one speaker comprises a single speaker oriented toward an upper surface of the device.

3. The conferencing device of claim 1 wherein the at least one microphone comprises a plurality of microphones having different orientations relative to a central axis of the device.

4. The conferencing device of claim 3 wherein each of the plurality of microphones comprises a directional microphone.

5. The conferencing device of claim 1 wherein the voice communication system corresponds to a telephone system and the signal interface is operable to interface with analog signals from the telephone system.

6. The conferencing device of claim 5 wherein the signal interface is operable to receive the analog signals over a four wire interface.

7. The conferencing device of claim 6 wherein the four wire interface corresponds to a phone handset interface.

8. The conferencing device of claim 5 wherein the signal interface is operable to receive the analog signals over a two wire interface, the signal interface comprising a hybrid.

9. The conferencing device of claim 1 wherein the signal interface is operable to interface with digital signals from the voice communication system.

10. The conferencing device of claim 9 wherein the signal interface comprises one of a USB interface, a Bluetooth interface, and a wireless interface which complies with the IEEE 802.11 standard.

11. The conferencing device of claim 1 further comprising analog-to-digital circuitry for converting the near-end speech energy to the near-end signals.

12. The conferencing device of claim 1 further comprising a power amplifier for driving the at least one speaker.

13. The conferencing device of claim 1 wherein the digital signal processor comprises a combiner block for generating a combination of the near-end signals.

14. The conferencing device of claim 13 wherein the combiner block employs a beam forming algorithm.

15. The conferencing device of claim 1 wherein the digital signal processor comprises a noise rejection block for rejecting noise associated with the near-end signals.

16. The conferencing device of claim 15 wherein the noise rejection block comprises one of a Wiener filters, at least one noise gate, and a spectral subtraction block.

17. The conferencing device of claim 1 wherein the digital signal processor comprises at least one echo canceller for rejecting energy in the near-end signals corresponding to far-end speech.

18. The conferencing device of claim 17 wherein the at least one echo canceller comprises a single echo canceller for rejecting the far-end speech energy from a combination of the near-end signals.

19. The conferencing device of claim 17 wherein the at least one echo canceller comprises a plurality of echo cancellers for rejecting the far-end speech energy from each of the near-end signals.

20. The conferencing device of claim 1 wherein the digital signal processor comprises a near-end multi-band signal processor which is operable to separate the near-end signals into a plurality of signal components each corresponding to one of the frequency bands, independently and dynamically control a dynamic range associated with each one of the plurality of signal components, modify at least one signal level associated with the plurality of signal components, and recombine the signal components.

21. The conferencing device of claim 1 wherein the digital signal processor comprises a line echo canceller for rejecting energy in the far-end signals corresponding to near-end speech.

22. The conferencing device of claim 1 wherein the digital signal processor comprises a far-end multi-band signal processor which is operable to separate the far-end signals into a plurality of signal components each corresponding to one of the frequency bands, independently and dynamically control a dynamic range associated with each one of the plurality of signal components, modify at least one signal level associated with the plurality of signal components, and recombine the signal components.

23. The conferencing device of claim 1 wherein the digital signal processor comprises a speaker compensation block which is operable to compensate for the non-ideal characteristics of the at least one speaker.

24. The conferencing device of claim 23 wherein the speaker compensation block comprises a minimum phase filter.

25. A conferencing device, comprising:
a speaker oriented toward an upper surface of the device;
a power amplifier for driving the speaker;
a plurality of directional microphones for capturing energy corresponding to near-end speech, the microphones having different orientations relative to a central axis of the device;
a signal interface for connecting to a voice communication system, the signal interface being operable to interface with one of analog signals from a telephone system, and digital signals from a computing device; and
a digital signal processor which is operable to combine near-end signals corresponding to the near-end speech energy using a beam forming algorithm, reject energy in the near-end signals corresponding to far-end speech, process the near-end signals in each of a plurality of frequency bands to improve intelligibility thereof, and transmit the near-end signals to the voice communication system via the signal interface, the digital signal processor further being operable to receive far-end signals from the voice communication system via the signal interface, reject energy in the far-end signals corresponding to near-end speech, process the far-end signals in each of the plurality of frequency bands, compensate for the non-ideal characteristics of the speaker, and transmit the far-end signals for presentation over the speaker.
